(19) United States
(12) Patent Application Publication
(10) Pub. No.: US 2009/0153477 A1
(43) Pub. Date: Jun. 18, 2009

(54) Computer mouse glove

(76) Inventor: Valentin L. Saenz, Bridgeport, CT (US)

Correspondence Address: ADVANTIA LAW GROUP, 9035 SOUTH 1300 EAST, SUITE 200, SANDY, UT, 84094, US

(21) Appl. No.: 11/954,609

(22) Filed: Dec. 12, 2007

(51) Int. Cl. G06F 3/033; G09G 5/08

(52) U.S. Cl. 345/158; 345/167; 345/157

(57) ABSTRACT

A computer mouse glove for transferring computer mouse functions to the hand of a computer user. The glove includes: a glove member having finger fittings and a thumb fitting; a computer cursor control system having buttons and a tracking system having an optical tracking device; a computer module; a power module; a connection module; a tracking ball; and a power switch. The glove member encases a user's hand. The computer cursor control system controls functions of a cursor on a computer screen. The buttons provides mouse electrical switching functions. The tracking system controls movement of the cursor on a computer screen. The power module provides energy to the computer glove mouse. The connection module transmits electronic signals from the computer glove mouse to computer module. The tracking ball controls movement of the computer cursor. The power switch enables a user to select either the tracking ball or optical tracking device.

### BACKGROUND OF THE INVENTION

1. Field of the Invention

The present invention relates to computer mouse gloves, specifically a computer mouse glove for transferring mouse functions to the hand of a computer user.

2. Description of the Related Art

In the related art, it has been known to use a computer mouse, which refers to the type of user interface device which permits a computer operator to move a cursor in any directions in a plane of a computer generated video display and to exercise any one predetermined set of control functions at any location of the cursor. These functions are well known in the art and include a select function and a drag function and so forth. Typically, a computer mouse is a hand held device which the operator rolls over the X-Y plane of a digitizer tablet, for example, to move the cursor in the video display. The mouse typically has two to three click buttons which enable the operator to exercise predetermined set of functions including select and drag. The mouse includes logic circuitry wired to the computer. The operator uses the mouse to control cursor movement and uses a keyboard for data entry. One disadvantage of the conventional computer mouse is that the operator must remove one hand from the computer keyboard whenever it is desired to operate the mouse and to re-establish the position of the hand on the keyboard after finishing a given movement of the mouse. Thus, there arises an inherently wasteful back and forth motion of the hand between the mouse and the keyboard. Some improvements have been made in the field. Examples include but are not limited to the references described below, which references are incorporated by reference herein:

U.S. Pat. No. 6,154,199, issued to Butler, discloses a hand positioned mouse that functions as a computer input device. The hand positioned mouse has an article that is worn on the hand of a computer user. The article can be in the form of a glove, half glove, sleeve, bracket or other type of configurations that can be worn on and supported on the hand. A support, such as a socket, is attached to the side of the article. The support is positioned at a location adjacent to the thumb. A tracking ball is contained within the support or socket. Electronic sensors track the movement of the tracking ball. Electrical signals are produced according to the rotation of the tracking ball. At least one switch is contained on the article for providing switch functions of the mouse. The switch is located on a location corresponding to the palm. The electrical signal and the switching functions are transmitted to the computer by a connector cord or by radio waves. This configuration allows the computer user to keep both hands on the keyboard and eliminates the need to move the hand back and forth between the keyboard and the mouse. In addition, the hand positioned mouse of this invention is ideal for playing computer games and interacting with such services as web TV. This invention can provide mouse operations apart from the keyboard and does not require a table top or keyboard for operation

U.S. Pat. No. 6,097,369, issued to Wambach, discloses a glove worn on the hand of a computer operator provides a computer mouse function for a computer having a video display highlighted by a cursor, in which the apparatus senses the direction of movement of an element of a computer operator's body and transmits corresponding commands to the computer to move the cursor in the video display in a corresponding direction, whereby two-dimensional movement of the cursor reflects movements of the body element. In one embodiment of the invention, cursor motion is controlled by lateral motion of the operator's wrist and vertical motion of the operator's index finger, whereby movement of said cursor follows the direction of movement of the wrist and index finger. Click button on various fingers of the glove are activated by the thumb to provide mouse click functions.

U.S. Pat. No. 5,488,362, issued to Ullman et al., discloses a hand attachment is lined above and below a wrist portion with parallel conductive contacts. One set of contacts is connected to a signal generator which generates control signals for moving characters in a video game. The second set of contacts is connected to the video game. Placing the hand at an angle selectively connects the contacts, sending the desired direction control signal to the video game. Conductive contacts are also located on the thumb and fingertips. Placing the thumb in contact with any of the fingertips connects a static signal generator to the video game. The hand attachment may be a glove or a wrist cuff. The control signals generated by the hand attachment may be wirelessly transmitted to the video game.

U.S. Patent Application Publication No.: 2004/0012564, by Zngf et al., discloses a glove-like apparatus mounted on a user's hand to control the cursor movement and to click for providing functions of a computer mouse. The apparatus has a glove-like body with multiple finger tubes. A tilt sensor is mounted on the glove metacarpus, of which the roll angle of the hand is detected to determine the moving orientation of the cursor. Two pairs of bending sensors are mounted on the thumb tube and the index finger tube, each pair of the sensors is used to detect a bending angle of the corresponding finger. The bending of the thumb or the index finger at a time is used to move the cursor in the negative or the positive direction along the located orientation line. The data glove for cursor control is operated as a virtual mouse with a virtual tracking ball.

U.S. Patent Application Publication No.: 2003/0006962, by Bajramovic, discloses a computer input device on a glove includes fittings for a user's fingers and adjustable straps for fastening to a user's wrist. A tracking device for controlling cursor movement on a video display is affixed to the glove for positioning next to the end of one of the user's fingers. Pressure plates for controlling the various right and left mouse “clicking” functions are affixed to the glove for positioning next to the ends of the other of the user's fingers. Scrolling/paging buttons are located on the side of the fitting fitted to the index finger for pressing by the thumb. A transmitter is affixed to the glove for receiving signals from the tracking device, the pressure plates and the scrolling/paging buttons, and transmitting those signals to a computer for controlling cursor movement in the x-y plane on a video display and for controlling the various mouse “clicking” controls, which implement the “select” function, the “drag” function, the “scroll” function, the “page” function, and so forth.

U.S. Design Patent No.: D280,053, issued to Singer, discloses the ornamental design for a video game glove.

The inventions heretofore known suffer from a number of disadvantages which include being inconvenient, being limited in application, being limited in use, and being limited in versatility.

What is needed is a computer mouse gloves that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available computer mouse gloves. Accordingly, the present invention has been developed to provide a computer mouse glove for transferring mouse functions to the hand of a computer user.

There is one embodiment of a computer mouse glove for transferring computer mouse functions to the hand of a computer user. The glove may include: a glove member, that may be configured to substantially encase a user's hand, and may include: a first finger fitting that may be shaped to envelope a finger; a second finger fitting that may be shaped to envelope a finger; and a thumb fitting that may be shaped to envelope thumb.

According to one embodiment of the present invention, there is computer mouse glove that may include: a computer cursor control system that may be coupled the glove member, and/or may be configured to control the functions of a cursor on a computer screen, and/or may include: a first button that may be coupled to the first finger fitting, and/or may be configured to provide mouse electrical switching functions; a second button that be coupled to the second finger fitting, and/or may be configured to provide mouse electrical switching functions; and a tracking system, that may be coupled substantially in center portion of the palm of the glove member, and/or may be configured to control the movement of a cursor on a computer screen.

Another embodiment of the present invention may have: a power module that may be configured to provide energy to the glove computer mouse; and a connection module that may be coupled to the glove computer mouse, and/or may be configured to transmit electronic signals from the glove to a computer module.

In yet another embodiment of the present invention, the tracking system may include an optical tracking device; a tracking ball that may be coupled to the thumb fitting, and/or may be configured to control movement of a computer cursor via movement of the thumb fitting; and a power switch that may be in communication with the tracking ball and/or the optical tracking device, and/or may be configured to enable user to select either the tracking ball or the optical tracking device.

In still yet another embodiment of the present invention, the tracking system may include a light module that may be coupled to the optical tracking device, and/or may be configured to provide light to the optical tracking device.

In still yet a further embodiment of the present invention, the connection module may include: a wireless signal transmitting device; and a wireless signal receiving device that may be removably couplable to a computer.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a front elevational view of a computer mouse glove, according to one embodiment of the invention; and

FIG. 2 illustrates a block diagram of a computer mouse glove, according to one embodiment of the invention.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

As used herein, “comprising,” “including,” “containing,” “is, are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

Looking to the drawing figures, there is an embodiment of a computer mouse glove 100 for transferring computer mouse functions to the hand of a computer user. The glove, as illustrated, includes: a glove member 110 configured to substantially encase a user's hand 115, having: a first finger fitting 120 shaped to envelope a user's finger 117; a second finger fitting 130 shaped to envelope a user's finger 117; and a thumb fitting 140 shaped to envelope a user's thumb 119; and a computer cursor control system 150 coupled to the glove member 110 and electrically configured to control the movement and function of a cursor 125 displayed on a computer screen 127 such as Dell Inspiron Digital Entertainment Notebook, Dell, Inc., One Dell Way Round Rock, Tex. 78682.

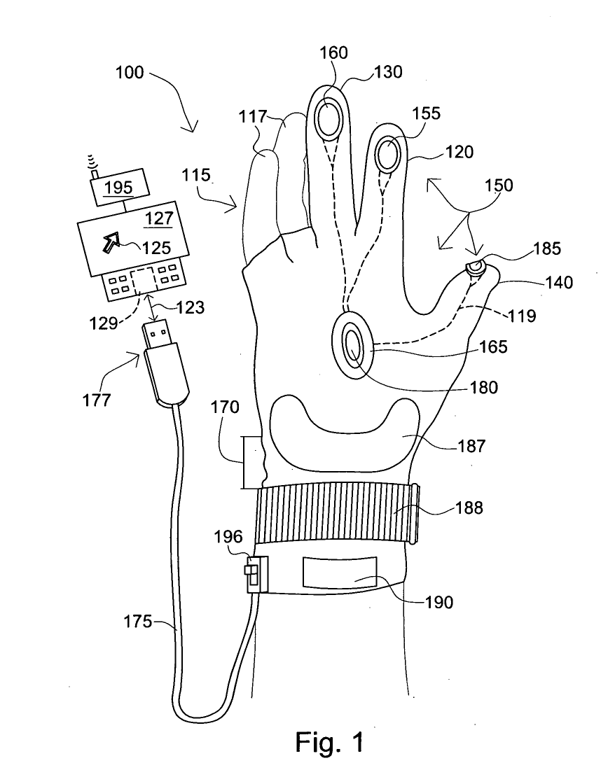

According to an embodiment of the present invention, the computer cursor control system 150, as shown in FIG. 1, includes: a first button 155, electrically coupled to the first finger fitting 120 and configured to provide mouse electrical switching functions to the glove member 110; and a second button 160 electrically coupled to the second finger fitting 130 and configured to provide mouse electrical switching functions to the glove member 110. The first button 155 and second button 160 on the glove functions substantially similar to the left and right buttons coupled to a conventional two-button computer mouse such as a Dell 2-Button USB Entry Mouse, One Dell Way Round Rock, Tex. 78682.

In another embodiment of the present invention, the figure shows a tracking system 165 disposed substantially in a center portion 161 of the palm of the glove member 110, and is configured to electromechanically control the movement of the cursor 125 on the computer screen 127 (also referred to as a computer or a computer module). The tracking system 165 includes: an optical tracking device 180 as described in U.S. Patent Application Publication 2003/0006962, by Bajramovic, which is incorporated by reference herein; disposed substantially in the center portion 161 of the palm of the glove member 110; a light module 183 such as a light emitting diode (LED); and a tracking ball 185 such described in U.S. Pat. No. 5,574,480, issued to Pranger et al., which is incorporated by reference herein, is coupleable to the thumb fitting 140 and configured to electromechanically control movement of the computer cursor 125 via movement of the thumb fitting 140.

In yet another embodiment of the present invention shown in FIG. 1, there is shown an power switch 196 disposed on the glove 100 such as a SPDT Slide Switch, Rapid Electronics Limited, Severalls Lane, Colchester, Essex C04 5JS United Kingdom, electrically configured to activate the glove 100 and is in electrical communication with the optical tracking device 180 and tracking ball 185, so as to enable a user to selectably employ either the tracking ball or the optical tracking device to control movement of the cursor 125 displayed in the computer screen or module 127 as described in paragraph 29 and shown in FIG. 1.

In yet another embodiment of the present invention, as shown in FIG. 1, includes: a power module 170, in the form of a battery such as a Duracell CR-V3 Ultra M3 Battery, Duracell, Inc., Berkshire Corporate Park, Bethel, Conn. 06801, electrically configured to provide electrical energy needed to activate the glove computer mouse 100; and a connection module such as a USB-5000-02M Cables Unlimited 6 ft (USB) 2.0 Universal Serial Bus Cable, We Love Macs, Inc., 2800 Bowers Avenue Santa Clara, Calif., 95051. According to one embodiment, the connection module 175 is coupleable to the glove computer mouse and configured to transmit radio frequency (RF) or electronic infrared signals from the glove 100 to the computer module 127, as described in paragraph 29, thereby enabling a user to remotely control the functionality of the computer 127 using the glove 100.

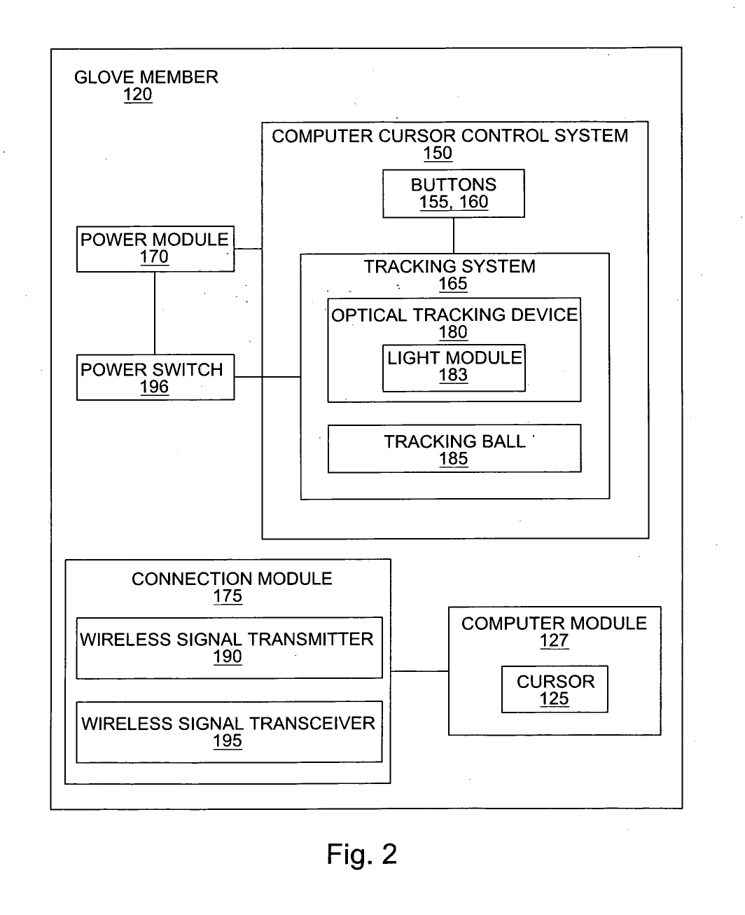

In still yet another embodiment of the present invention shown in FIG. 2, the connection module 175 comprises: a wireless communications signal receiving and transmitting device 190 such as a Wireless Integrated Circuit or Chip manufactured by Sony Electronics, 3300 Zanker Rd, San Jose, Calif. 95134 that may be electrically coupled to the glove 100 and in signal communication with a wireless communication signal transceiver 195 as described in U.S. Pat. No. 5,440,559, issued to Gaskill, which is incorporated by reference herein. The transceiver 195 is configured to be removably coupleable to the computer 127, as described in paragraph 30, thereby enabling a user to remotely control the functionality of the computer 127 using the glove 100 through a wireless communications network.

In operation, a user desiring to game, surf the Internet, or use other computer software applications may securely couple the glove 100 to his or her hand 115 via a strap 188 such as a snap assembly, hook and look fastener, etc. The user may then removably insert a connection module male plug 177 into a USB port 129, as indicated by arrow 123. The user may operate the glove in two modes. In the first mode, the user may opt to employ the glove 100 as a conventional mouse, as described in paragraph 30 by positioning the power switch 196 into an “Off” position, wherein the glove will be energized by alternating current (AC) source being provided to an activated computer 127, according to one embodiment. In the second mode, the user may choose to use the glove 100 as a wireless optical mouse such as a Wireless Optical Mouse 5000 for Windows USB & PS/2*Platinum*, Microsoft, Inc., Microsoft Corporation One Microsoft Way Redmond, Wash. 98052-6399, by positioning the power switch 196 into an “On” position, wherein the glove will receive electrical energy from a direct current (DC) source such as the battery 170, according to one embodiment. Using the glove in the second mode also allows the wireless signal transmitter 190, disposed on the glove 100, to be in signal communication with the wireless signal transceiver 195 coupled to the activated computer 127; thereby enabling the user to control the movement and functionality of the cursor 125 displayed in the computer screen 127 in a wireless network.

In the event the user elects the first mode of operating the glove 100, as described in paragraph 35, it is assumed that the optical tracking device 180, light module 183, wireless signal transmitter 190, and wireless signal transceiver 195 are deactivated in this mode. Therefore, the user may place his or hand face down and engage the computer cursor control system 150, comprising the buttons 155, 160 and the tracking ball 185, with a mouse pad or other surface. While gaming, surfing the Internet or performing other computer software applications, the user may then slide his or her hand over a surface to while rolling the tracking ball 185 with the thumb 119 to move the cursor 125 to various points on the computer screen 127. The user may then apply a downward force on button 155 with the middle finger 117 to perform software applications requiring the clicking of the left mouse button. Likewise, the user can apply a downward force on button 160 to perform software operations requiring the clicking of the right mouse button. The cease mouse clicking operations, the user may eliminate the force applied on the buttons 155, 160 user may lift his or her middle fingers 117 in an upward position.

In the event the user elects the second mode of operating the glove 100, as described in paragraph 35, it is assumed that the tracking ball 185 is deactivated in this mode. Again, the user may place his or hand face down and engage the computer cursor control system 150, comprising the buttons 155, 160 and the tracking system 165, with a mouse pad or other surface. The user may then slide his or her hand over a surface allowing the tracking system 165 and optical tracking device 180 to control movement of the cursor 125 to various points on the computer screen 127. In addition, the LED light 183 would also flash enabling the user to see the position of the glove relative to the surface, especially during hours of darkness. The user may then perform gaming and other computer software applications over a wireless network, as described in paragraph 35. Moreover, the user may manipulate the buttons 155, 160 as described in paragraph 37 to perform software applications requiring the clicking of the mouse buttons 155, 160.

Regardless of the mode of operating the glove 100, the pad 187 may be constructed of soft material such as foam, rubber, etc. enabling the user to comfortably employ the glove 100 and reduce the chances of hurting the hand, especially during prolonged use of the glove. In addition the glove member 110, finger fittings 120, 130, and thumb fitting 140 may be constructed of non-electrically conductive material such as leather, rubber, etc., thereby significantly reducing the chances of a user suffering from an electric shock while employing the glove 100.

Embodiments of the computer mouse glove 100 are convenient and very useful for gaming, web browsing, and other general personal computer applications. By freeing the user's hand 115 from having to grip a computer mouse, the glove would help reduce incidences of carpal tunnel syndrome (CTP), caused by continuous compression or squeezing of the nerves in the wrist. The glove 100 is particularly useful for gaming, wherein it allows the user to keep both hands near the computer keyboard to press keys while still utilizing one of those hands to perform mouse functions to move the cursor 125.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

Although FIGS. 1 and 2 illustrated the glove 100 being coupled to a user's right hand 115, one skilled in the art would appreciate that the glove may be constructed to be coupleable to the user's left hand, according to various embodiments.

Additionally, although FIGS. 1 and 2 illustrate the tracking system 165, optical tracking device 180 and light module 183 being disposed substantially in the center portion 161 of the palm of the glove member 110, it is envisioned that the tracking system, optical tracking device, and/or light module may be disposed off-center of the palm of the glove member 110, according to various embodiments.

It is envisioned that the buttons 155, 160; trackball 185; tracking system 165; power module 170; connection module 175; optical tracking device 180; light module 183; trackball 185; pad 187; strap 188; wireless signal transmitting device 190; and/or switch 196 may be disposed in various areas on the glove member 110, according to alternative embodiments.

It is also envisioned that the glove 100 may be employed with a many types of computers 127 such as desktops, laptops, personal digital assistants, etc. and wireless signal transceivers 195 such as routers, etc. having various shapes, sizes and designs, etc., according to various embodiments.

It is further envisioned that the connection module male plug 177 may be removably inserted into computer USB ports 129 disposed on various areas on various types and models of computers 127, according to alternative embodiments.

It is expected that there could be numerous variations of the design of this invention. An example is that the glove member 110; finger fittings 120, 130; computer module 127; computer cursor control system 150; buttons; 155, 160; tracking system 165; power module 170; connection module 175; optical tracking device 180; light module 183; tracking ball 185; pad 187; strap 188; wireless signal transmitting device 190; transceiver 195 and/or switch 196 may vary in length, width, size, design, thickness, color, shape, etc., according to various embodiments.

Finally, it is envisioned that the components of the device may be constructed of a variety of materials, such as cloth, leather, fabric, cotton, foam material, plastic, composite material, polymer, copper, metal alloys, etc.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A computer mouse glove for transferring computer mouse functions to the hand of a computer user, comprising:
a glove member, configured to substantially encase a user's hand, the glove member including:
a first finger fitting shaped to envelope a finger;
a second finger fitting shaped to envelope a finger; and
a thumb fitting shaped to envelope thumb;
a computer cursor control system coupled the glove member, configured to control the functions of a cursor on a computer screen, the computer cursor control system including:
a first button coupled to the first finger fitting, configured to provide mouse electrical switching functions;
a second button coupled to the second finger fitting, configured to provide mouse electrical switching functions;
a tracking system coupled substantially in center portion of the palm of the glove member, configured to control the movement of a cursor on a computer screen;
a power module, configured to provide energy to the glove computer mouse;
a connection module coupled to the glove computer mouse, configured to transmit electronic signals from the glove to a computer module.

2. The glove computer mouse of claim 1, wherein the tracking system further includes an optical tracking device.

3. The glove computer mouse of claim 1, wherein the tracking system further includes a tracking ball coupled to the thumb fitting, and configured to control movement of a computer cursor via movement of the thumb fitting.

4. The glove computer mouse of claim 1, wherein the tracking system further includes an a light module coupled to optical tracking device; and configured to provide light to the optical tracking device.

5. The glove computer mouse of claim 1, wherein the tracking system further includes a power switch in communication with the tracking ball and the optical tracking device, configured to enable user to select either the tracking ball or the optical tracking device.

6. The glove computer mouse of claim 1, wherein the connection module includes:
a wireless signal transmitting device; and
a wireless signal transceiver removably couplable a computer.

7. The glove computer mouse of claim 1, wherein the power module comprise a battery.

8. A computer mouse glove for transferring computer mouse functions to the hand of a computer user, consisting essentially of:
a glove member, configured to substantially encase a user's hand, the glove member including:
a first finger fitting shaped to envelope a finger;
a second finger fitting shaped to envelope a finger; and
a thumb fitting shaped to envelope a thumb;
a computer cursor control system coupled the glove member, configured to control the functions of a cursor on a computer screen, the computer cursor control system including:
a first button coupled to the first finger fitting, configured to provide mouse electrical switching functions;
a second button coupled to the second finger fitting, configured to provide mouse electrical switching functions;
a tracking system coupled substantially in center portion of the palm of the glove member, configured to control the movement of a cursor on a computer screen;
a power module, configured to provide energy to the glove computer mouse;
a connection module coupled to the glove computer mouse, configured to transmit electronic signals from the glove to a computer module.

9. The glove computer mouse of claim 8, wherein the tracking system further includes an optical tracking device.

10. The glove computer mouse of claim 8, wherein the tracking system further includes a light module coupled to the optical tracking device, and configured to provide light to the optical tracking device.

11. The glove computer mouse of claim 8, wherein the tracking system further includes a tracking ball coupled to the thumb fitting, configured to control movement of a computer cursor via movement of the thumb fitting.

12. The glove computer mouse of claim 8, wherein the tracking system further includes a power switch in communication with the tracking ball and the optical tracking device, configured to enable user to select either the tracking ball or the optical tracking device.

13. The glove computer mouse of claim 8, wherein the connection module includes:
a wireless signal transmitting device; and
a wireless signal transceiver removably couplable a computer.

14. The glove computer mouse of claim 8, wherein the power module comprise a battery.
